(19) United States
(12) Patent Application Publication
(10) Pub. No.: US 2023/0245022 A1
(43) Pub. Date: Aug. 3, 2023

(54) Customer-Intelligence Dashboard

(71) Applicant: involve.ai, Inc., Santa Monica, CA (US)

(72) Inventors: Gaurav BHATTACHARYA, Santa Clarita, CA (US); Saumya BHATNAGAR, Santa Clarita, CA (US); Hardika NARULA, San Jose, CA (US); Kirill PAKHRYAEV, Saint Petersburg (RU); Geoffrey RATHINAPANDI, Round Rock, TX (US)

(21) Appl. No.: 17/589,108

(22) Filed: Jan. 31, 2022

(51) Int. Cl. G06Q 10/06; G06Q 30/02

(52) U.S. Cl. CPC G06Q 10/06315; G06Q 10/0637; G06Q 30/0201; G06Q 30/0211

(57) ABSTRACT

In one embodiment, a method includes accessing customer data of a business entity at multiple data sources. The customer data includes product-usage signals, support signals, and communication signals associated with each of multiple customers and each of one or more products of the business entity. At least some of the customer data is quantitative, and at least some of the customer data is qualitative. The method includes analyzing the customer data by applying one or more AI models to the customer data and, based on the analysis of the customer data, determining, for each of the customers and each of the products a score for each of multiple KPIs for the business entity that include one or more of the following interaction frequency; product usag; NPS or CSAT score; number of support tickets; severity of support tickets; customer sentiment; customer-owner pulse; up-sells or down-sells; or customer maturity.

### TECHNICAL FIELD

This disclosure generally relates to customer intelligence.

### BACKGROUND

Customer retention is crucial to, and often a big pain point for, businesses. While acquiring new customers is important to growth, retaining customers is critical to business' survival. The cost to acquire a new customer can be five to 25 times more than retaining an existing customer. By keeping and expanding their current customers, businesses may reduce their customer-acquisition cost, increase their profitability, and improve their long-term business health.

Customer intelligence facilitates customer retention. However, customer intelligence for effective customer retention at scale requires the collection, unification, and complex analysis of vast amounts of disparate and dispersed quantitative and qualitative data. It also requires intuitive presentation of complex information to users who need to understand the data to gain actionable insights into customer experience and customer needs.

### SUMMARY OF PARTICULAR EMBODIMENTS

Particular embodiments help the user (and the business that the user is associated with) better understand and retain customers through more accurate predictions of which customers are most at risk for cancellation, leading them into more targeted intervention strategies. By combining customer data with machine-learning algorithms, particular embodiments enable businesses to more accurately predict when a customer may be about to leave or be ready for upselling. Particular embodiments may also provide more valuable insights into what types of intervention tactics may work better for a particular customer and particular case. Particular embodiments may help businesses become proactive, action-oriented, and data-driven post-sales organizations, as opposed to more gut-based and reactive firehouses.

Particular embodiments provide a single platform where a user (and the business associated with the user) may obtain a deeper understanding of where money is being spent and on what fronts. Particular embodiments may also give the user (and the business associated with the user) more control over customer experience from on-boarding to renewals, while also identifying opportunities for increased revenue by identifying areas ripe with profit early during the customer relationship.

Particular embodiments may help a business entity to see the big picture of its customer accounts and growth opportunities. In particular embodiments, a user may receive insights on customer accounts and products so the user may focus on planning growth strategies while customer owners (or customer-success managers (CSMs)) focus on fighting churn and turning at-risk customers into more loyal customers. Particular embodiments handle tedious, manual back-end tasks to reduce time requirements associated with those tasks and to help generate more accurate, reliable insights. Particular embodiments capture and analyze both quantitative and qualitative information to obtain more accurate predictions and develop more accurate customer profiles. Particular embodiments provide prescriptive insights and predictions facilitating progress toward a business's growth goals.

Particular embodiments facilitate customer intelligence by automatically collecting, unifying, and carrying out complex analyses of vast amounts of disparate and dispersed quantitative and qualitative customer data for users. Particular embodiments provide intuitive presentation of complex information to users who need to understand the data to gain actionable insights into customer experience and customer needs.

Although particular embodiments are described as providing particular advantages, particular embodiments may provide none, some, or all of these advantages.

### BRIEF DESCRIPTION OF THE DRAWINGS

FIG. 1 illustrates an example network environment with an example customer-intelligence system.

FIG. 2 illustrates an example customer-intelligence system.

FIG. 3 illustrates an example customer-intelligence dashboard.

FIG. 4 illustrates an example detailed view of a portion of an example customer-intelligence dashboard.

FIG. 5 illustrates example weighting of example key performance indicators (KPIs) in example customer-health score generation.

FIG. 6 illustrates example feature enablement in an example customer-health score.

FIG. 7 illustrates an example Elbow-method graph.

FIGS. 8A-8C illustrates an example presentation of example general information on a customer in an example customer-intelligence dashboard.

FIGS. 9A-9B illustrates example presentation of example key indicators for a customer.

FIG. 10 illustrates example presentation of example customer history for an example customer on an example customer-intelligence dashboard.

FIG. 11 illustrates example presentation of example tracked contacts for an example customer on an example customer-intelligence dashboard.

FIG. 12 illustrates example presentation of example information cards on an example customer on an example customer-intelligence dashboard 302.

FIG. 13 illustrates an example window for example prediction feedback on an example customer-intelligence dashboard 302.

FIG. 14 illustrates example presentation of KPIs and their contributions to a customer-health score.

FIG. 15 illustrates an example method for providing a customer-intelligence dashboard.

FIG. 16 illustrates an example computer system.

### DESCRIPTION OF EXAMPLE EMBODIMENTS

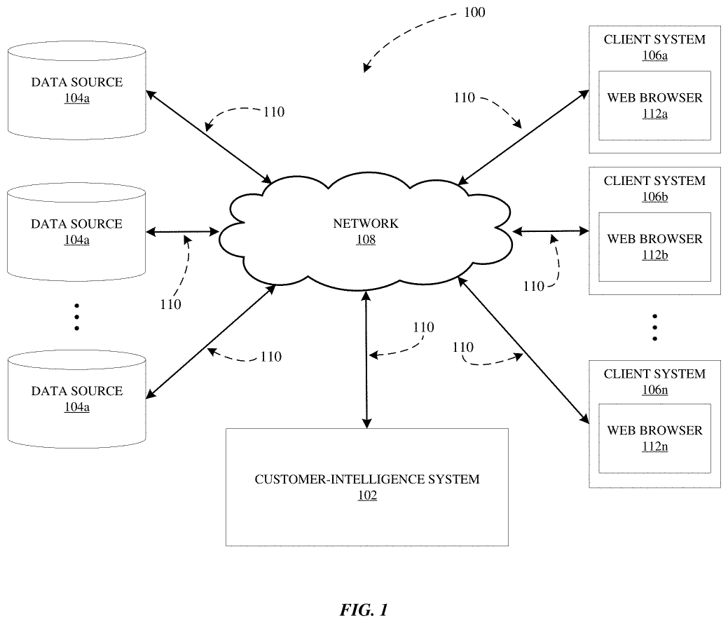

FIG. 1 illustrates an example network environment 100 with an example customer-intelligence system 102. In the example of FIG. 1, network environment 100 includes customer-intelligence system 102, data sources 104, and client systems 106 connected to each other by a network 108. Although FIG. 1 illustrates a particular arrangement of customer-intelligence system 102, data sources 104, client systems 106, and network 108, this disclosure contemplates any suitable arrangement of customer-intelligence system 102, data sources 104, client systems 106, and network 108. As an example and not by way of limitation, customer-intelligence system 102 may be connected to one or more data sources 104 directly, bypassing network 108. As another example, customer-intelligence system 102 may be connected to one or more client systems 106 directly, bypassing network 108. As another example, two or more data sources 104 may be connected to each other directly, bypassing network 108. As another example, two or more client systems 106 may be connected to each other directly, bypassing network 108. As another example, customer-intelligence system 102 may be physically or logically co-located with one or more data sources 104. As another example, customer-intelligence system 102 may be physically or logically co-located with one or more client systems 106. As another example, one or more data sources 104 may be physically or logically co-located with one or more client systems 106. As another example, two or more data sources 104 may be physically or logically co-located with each other. As another example, two or more client systems 106 may be physically or logically co-located with each other. Moreover, although FIG. 1 illustrates a particular number of customer-intelligence systems 102, data sources 104, client systems 106, and networks 108, this disclosure contemplates any suitable number of customer-intelligence systems 102, data sources 104, client systems 106, and networks 108. As an example and not by way of limitation, network environment 100 may include multiple customer-intelligence systems 102 and multiple networks 108.

This disclosure contemplates any suitable network 108. As an example and not by way of limitation, one or more portions of network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 108 may include one or more networks 108.

Links 110 may connect customer-intelligence system 102, data sources 104, and client systems 106 to network 108 or to each other. This disclosure contemplates any suitable links 110. In particular embodiments, one or more links 110 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 110 each include an ad hoc network, an intranet, an extranet, a VPN, a LAN, a WLAN, a WAN, a WWAN, a MAN, a portion of the Internet, a portion of the PSTN, a cellular-technology-based network, a satellite-communications-technology-based network, another link 110, or a combination of two or more such links 110. Links 110 need not necessarily be the same throughout network environment 100. One or more first links 110 may differ in one or more respects from one or more second links 110.

In particular embodiments, a client system 106 may be an electronic device including one or more hardware, software, or embedded logic components or a combination of two or more such components capable of carrying out functions implemented or supported by client system 106. As an example and not by way of limitation, a client system 106 may include a computer system such as a desktop computer, notebook or laptop computer, netbook, a tablet computer, mobile telephone, augmented-reality (AR) or virtual-reality (VR) device, other suitable electronic device, or any suitable combination thereof. This disclosure contemplates any suitable client systems 106. A client system 106 may enable a user at client system 106 to access network 110 and communicate with customer-intelligence system 102. As an example, a client system 106 may be associated with a business entity (which many be an individual or a company) and a user at client system 106 may access customer-intelligence system 102 using a web browser 112 at client system 106 and interact with one or more web-based applications hosted by customer-intelligence system 102 (such as, for example, customer-intelligence dashboard 302 described below) to gain actionable insights into customer experience and customer needs to proactively drive customer retention by the business entity. Herein, reference to a user may encompass the business entity that the user is associated with, and vice versa, where appropriate. Herein, reference to a business may encompass a business entity, and vice versa, where appropriate. Herein, reference to a client may encompass a user at a client system 106 or a business entity that the user is associated with, and vice versa, where appropriate. Client systems 106 need not necessarily be the same throughout network environment 100. One or more first client systems 106 may differ in one or more respects from one or more second client systems 106.

In particular embodiments, a client system 106 may include a web browser 112, such as MICROSOFT EDGE, GOOGLE CHROME, MOZILLA FIREFOX, or APPLE SAFARI, and web browser 112 may have one or more add-ons, plug-ins, or other extensions. A user at a client system 106 may enter a Uniform Resource Locator (URL) or other address directing web browser 112 at client system 106 to a particular server (such as a server associated with customer-intelligence system 102), and web browser 112 may generate a Hyper Text Transfer Protocol (HTTP) request and communicate the HTTP request to that server. The server may accept the HTTP request and communicate to client system 106 one or more Hyper Text Markup Language (HTML) files responsive to the HTTP request. Client system 106 may render a webpage based on the HTML files from the server for presentation to the user. This disclosure contemplates any suitable webpage or other source files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage or other source files (which a web browser 112 may use to render the webpage) and vice versa, where appropriate.

Data sources 104 may store various types of information. In particular embodiments, the information stored in a data source 104 may be organized according to specific data structures. In particular embodiments, one or more data sources 104 may each be a relational, columnar, correlation, or other suitable database. Although this disclosure describes particular types of databases, this disclosure contemplates any suitable types of databases. In particular embodiments, a data source 104 may include one or more interfaces that enable customer-intelligence system 102 or one or more client systems 106 to manage, retrieve, modify, add, or delete information stored in data source 104. Data sources 104 may be customer-relationship management (CRM) platforms or other sources of customer data, such as, for example, SALESFORCE, CHURNZERO, SNOWFLAKE, JIRA, ZENDESK, GMAIL, MICROSOFT OUTLOOK, SLACK, ZOOM or any other suitable CRM platform or other source of customer data. Data sources 104 need not necessarily be the same throughout network environment 100. One or more first data sources 104 may differ in one or more respects from one or more second data sources 104.

The customer data in data sources 104 may be dispersed and disparate and may be quantitative or qualitative. Examples of dispersed qualitative data include e-mail, call notes, and chat records. Customer data stored in data sources 104 may include product-usage, support, and communication signals and other suitable customer data. As an example and not by way of limitation, as between a particular business and a particular customer of that business, customer data may include one or more of the following, in any suitable combination: support tickets for the customer; assessments of the business's relationship with the customer (or “customer health”) by the business's customer owner (or CSM) for the customer; e-mails between the business and customer; notes about the customer by the business's customer owner (or CSM) for the customer; transcriptions of telephone calls between the business and customer; intercom chats between the business and customer; text messages between the business and customer; notes about telephone calls between the business and customer; net promoter score (NPS) or customer satisfaction (CSAT) comments; written interaction between the business and customer;

relevant logins by the customer; relevant sessions by the customer; relevant session times for the customer; relevant API calls by the customer; relevant API throttle limits for the customer; relevant API usage cyclicity by the customer; relevant report downloads by the customer; relevant page views by the customer; transactions between the business and customer; billable actions by the business for the customer; non-billable actions by the business for the customer; value-added actions by the business for the customer; relevant product add-ons requested by the customer; relevant time on product by the customer; relevant quote-to-order conversion for the customer; invoices generated by the business for the customer; order volume for the customer; a maturity level of the customer with respect to the business; identification of the business's customer owner (or CSM) for the customer; relevant revenue (e.g. annual recurring revenue (ARR)) attributable to the customer; relevant renewal dates for the customer with respect to the business. Although particular customer data in particular data sources is described and illustrated, this disclosure contemplates any suitable customer data in any suitable data sources. Herein, reference to a product provided by a business may encompass a service provided by the business, and vice versa, where appropriate.

Customer-intelligence system 102 may be a network-addressable computing system that can host an online customer-intelligence platform providing one or more customer-intelligence web-based applications. Customer-intelligence system 102 may integrate with data sources 104 and, through those integrations, access customer data stored at data sources 104. Customer-intelligence system 102 may analyze the customer data and, based on the analysis, generate predictions about customer churn and opportunities for expanding revenue and identify tasks to improve overall customer experience. Customer-intelligence system 102 may organize that information for presentation to users at client systems 106, who may then act on that information.

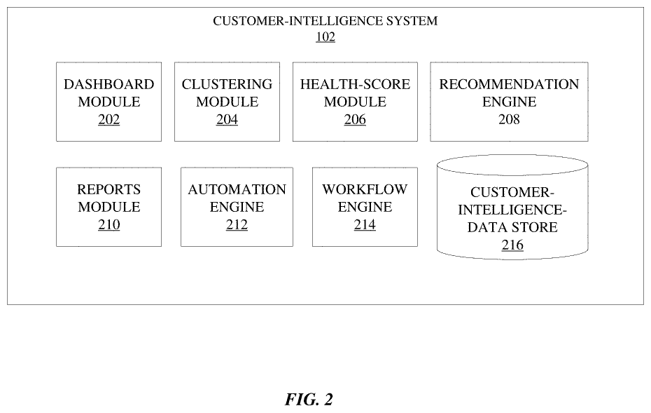

FIG. 2 illustrates an example customer-intelligence system 102. In the example of FIG. 2, customer-intelligence system 102 includes a dashboard module 202, clustering module 204, health-score module 206, recommendation engine 208, reports module 210, automation engine 212, workflow engine 214, and customer-intelligence-data store 216. In particular embodiments, dashboard module 202, clustering module 204, health-score module 206, recommendation engine 208, reports module 210, automation engine 212, workflow engine 214, and customer-intelligence-data store 216 are hardware, software, or embedded logic components or a combination of two or more such components capable of carrying out particular functions of customer-intelligence system 102. In particular embodiments, the information stored in customer-intelligence-data store 216 may be organized according to specific data structures, such as, for example, a relational, columnar, correlation, or other suitable database. Although customer-intelligence system 102 is described and illustrated as including particular components in a particular arrangement, this disclosure contemplates customer-intelligence system 102 including any suitable components in any suitable arrangement. As an example, customer-intelligence system 102 may include one or more of each of dashboard module 202, clustering module 204, health-score module 206, recommendation engine 208, reports module 210, automation engine 212, workflow engine 214, and customer-intelligence-data store 216. As another example, one or more of each of dashboard module 202, clustering module 204, health-score module 206, recommendation engine 208, reports module 210, automation engine 212, workflow engine 214, and customer-intelligence-data store 216 may be physically or logically co-located with each other in whole or in part or share one or more hardware, software, or embedded-logic components with each other.

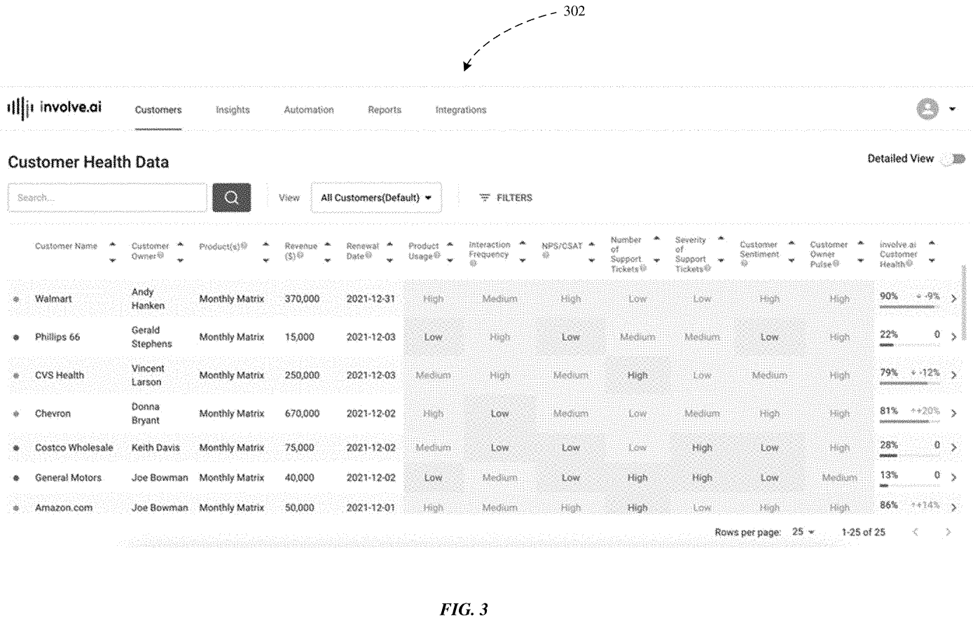

In particular embodiments, as described more fully below, dashboard module 202 generates for presentation to a client a customer-intelligence dashboard (an example of which is illustrated as customer-intelligence dashboard 302 in FIGS. 3-13) that unifies customer data and generates predictions about the client's customer churn, customer renewal, or customer upsell; clustering module 204 segments customer data into component parts by analyzing similarities among the feature space; health-score module 206 generates customer-health scores for presentation to users in customer intelligence dashboard 302; recommendation engine 208 uses information from dashboard 302 to generate actionable recommendations based on data changes on dashboard 302; reports module 210 uses the dashboard to generate high-level reporting data summarizing customer revenue and churns and upsells, along with trends around the KPIs; automation engine 212 enables users to create automation rules to update static data and values on dashboard 302; workflow engine 214 enables a user to create communication workflows based on data-value changes on dashboard 302; and customer-intelligence-data store 216 stores customer data processed by customer-intelligence system 102 and other information generated by customer-intelligence system 102.

In particular embodiments, customer-intelligence dashboard 302 is an artificial intelligence (AI)-driven early-warning dashboard that helps businesses reduce churn and accelerate revenue growth, unlocking predictive customer intelligence from existing customer data. More information on the use of AI in customer intelligence may be found in U.S. patent application Ser. No. 17/515,314, filed 29 Oct. 2021 and entitled Named Entity Recognition System for Sentiment Labeling, which is incorporated herein by reference in its entirety. In particular embodiments, AI automatically picks up on trends and patterns as the business gains more customers. The more data and feedback the AI receives, the better its predictions become. In particular embodiments, the customer-intelligence dashboard unifies KPIs for customer experience from product usage, support, and communication signals from data sources 104. These signals then go through particular algorithms to predict top churn risks, revenue expansion opportunities, and tasks to improve overall customer experience.

In particular embodiments, customer-intelligence dashboard 302 is intuitive, automated, actionable, and AI-driven and facilitates the automatic capture and analysis of customer data for insights to predict potential customer issues and better understand customer-growth potential. In particular embodiments, to generate these predictions, customer-intelligence system 102 integrates with over 176 data sources 104 used by clients. Through these integrations, customer-intelligence system 102 receives access to customer data in data sources 104. While this data may vary depending on the business model, particular embodiments assess and analyze particular categories and KPIs to create more comprehensive customer profiles and provide more accurate churn prediction. In particular embodiments, one or more of the following categories are assessed and analyzed: customer name; customer owner (or CSM); product(s); revenue (e.g. annual recurring revenue (ARR)); or renewal date. In particular embodiments, one or more of the following KPIs are assessed and analyzed: product usage (which may be the frequency at which the customer uses or purchase the product(s)); interaction frequency (which may be the frequency of interaction between the customer and the business and may be measured in e-mail, telephone calls, and visits); NPS/CSAT (which may be the level of customer satisfaction); number of support tickets (which may be the number of support requests submitted by the customer); severity of support tickets (which may be the severity of the issues in the support tickets); customer sentiment (which may be an analysis of written interaction between the business and customer); customer-owner pulse (which may be an assessments of the business's relationship with the customer (or “customer health”) by the business's customer owner (or customer-success manager (CSM) for the customer); up-sells/down-sells (which may be an increase or decrease in revenue generated from the customer); or customer maturity (which may be where the customer is in a customer lifecycle with respect to the business). Although particular categories and particular KPIs are described and illustrated, this disclosure contemplates any suitable categories and any suitable particular KPIs.

In particular embodiments, product usage by a customer may be determined from one or more of the following in any suitable combination: logins, sessions, session times, number of users timeframe, number of API calls, APR throttle limits, API usage cyclicity, report downloads, page views, number of transactions processed, dollar value of transactions processed, billable actions versus non-billable actions, number of value-added actions, number of product add-ons, time on product, quote-to-order conversion, generated invoices, or order volume. In particular embodiments, interaction frequency may be determined from one or more of the following: e-mails, CSM notes, support-ticket descriptions, transcriptions of telephone calls, intercom chats, text messages, telephone calls, telephone-call notes, or NPS or CSAT comments. Although particular KPIs are described as being determined from particular customer data, this disclosure contemplates any suitable KPIs being determined from any suitable customer data.

In particular embodiments, each KPI measures a different aspect of a customer. As an example, product usage may indicate how often the customer is using a particular product, which may indicate how important that product is to the customer. As another example, interaction frequency between the customer and the business (whether e-mails, calls, or visits) may indicate the customer's commitment or loyalty to the business. However, interaction frequency alone may be insufficient to fully indicate the customer's commitment or loyalty to the business. The content of those interactions (what the customer writes or says in those e-mails, calls, and visits) is important. This is represented by renewal sentiment. When dealing with such complex customer data, particular embodiments use AI to calculate the business's unique KPIs and automatically compares them to industry best practices, which results in more suitable or reasonable value for the business's unique situations.

FIG. 3 illustrates an example customer-intelligence dashboard 302. Customer-intelligence dashboard 302 may be generated by dashboard module 202 working with one or more other components of customer-intelligence system 102 in response to a request from a user at a client system 106. In the example of FIG. 3, intelligence dashboard 302, as generated for the user, includes information for the following customers, which may be customers of the business entity that the user is associated with: WALMART, PHILLIPS 66, CVS HEALTH, CHEVRON, COSTCO WHOLESALE, GENERAL MOTORS, and AMAZON. For each customer, the following categories are presented: (1) customer name; (2) customer owner (or CSM); (3) product(s); (4) revenue; and (5) renewal date. The following KPIs are also presented: (1) product usage; (2) interaction frequency; (3) NPS/CSAT; (4) number of support tickets; (5) severity of support tickets; (6) customer sentiment; and (7) customer-owner pulse. Additional KPIs that could be presented, but are not shown in FIG. 3, include (8) up-sells/down-sells and (9) customer maturity. Although customer-intelligence dashboard 302 is described and illustrated as presenting particular information in a particular arrangement, this disclosure contemplates customer-intelligence dashboard 302 presenting any suitable information in any suitable arrangement.

Particular embodiments set a threshold value (e.g. high, medium, or low) for customer health. In particular embodiments, these values are benchmarked across multiple businesses per product per ARR range per quarter. This metric may indicate to a user when and what action should be taken (e.g. whether to prevent churn for a customer with a low health score or capture an upsell opportunity for a customer with a high health score). For each KPI for each customer, customer-intelligence dashboard 302 presents a color-coded score of low, medium, or high. With some KPIs, a low score is considered positive and a high score is considered negative. With other KPIs, a high score is considered positive and a low score is considered negative. A KPI score of medium may be considered neutral. A positive KPI score may be color coded green, a negative KPI score may be color coded red, and a neutral KPI score may be color coded yellow. In the example of FIG. 3, high product usage is considered positive, medium product usage is considered neutral, low product usage is considered negative, high interaction frequency is considered positive, medium interaction frequency is considered neutral, low interaction frequency is considered negative, high NPS/CSAT is considered positive, medium NPS/CSAT is considered neutral, low NPS/CSAT is considered negative, high customer sentiment is considered positive, medium customer sentiment is considered neutral, low customer sentiment is considered negative, high customer-owner pulse is considered positive, medium customer-owner pulse is considered neutral, low customer-owner pulse is considered negative, low number of support tickets is considered positive, medium number of support tickets is considered neutral, high number of support tickets is considered negative, low severity of support tickets is considered positive, medium severity of support tickets is considered neutral, and high severity of support tickets is considered negative. These KPI scores may be color coded accordingly in customer-intelligence dashboard 302. This color coding may facilitate a user more quickly understanding which customer relationships are strong (and thus present up-sell opportunities), which are weak (and thus at risk for churn), and, more particularly, in each group, what aspects of those relationships are contributing positively or negatively to their overall status.

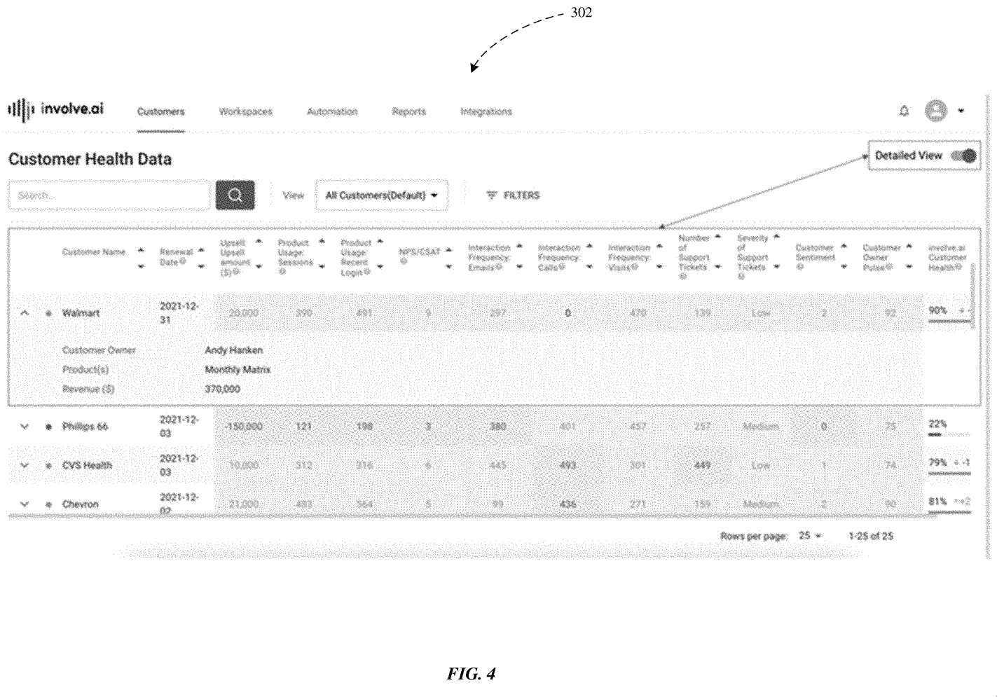

FIG. 4 illustrates an example detailed view of a portion of customer-intelligence dashboard 302, where the numerical values for those scores or other detailed summaries are presented, enabling the user to obtain more detail on those KPIs. Each KPI may be broken down into an individual metric contributing to the customer's health score. As an example, product usage may include login information, number of sessions, etc. As another example, interaction frequency may be divided into e-mails, telephone calls, and visits. This may enable a user to view a clearer demarcation of the health-score values, how they contribute to the threshold established, and which metrics should change to improve that score.

Returning to FIG. 3, customer-intelligence dashboard 302 also presents a customer-health score (shown on the right side of customer-intelligence dashboard 302) for each customer, along with a change (positive or negative) since the last health score. In particular embodiments, a health score for a customer indicates a likelihood that the customer will churn, renew, or upsell. Generally, the higher the health score, the stronger the relationship with the customer and the greater the possibility of up-selling the customer. Similarly, the lower the health score, the weaker the relationship with the customer and the greater the possibility of churn. Generally, the more neutral the health score, the more neutral the relationship with the customer and the greater the possibility of the customer renewing without up-selling. In particular embodiments, a customer with a health score that has fallen below a threshold value may represent a high probability of churn. The business may want to take preventative measures with that customer before churn occurs. A higher customer-health score may indicate that the customer has been using the business's product(s) frequently and is satisfied and turning into a loyal customer. A loyal customer may be a good candidate for upsell or cross-sell by the business.

In particular embodiments, to generate a customer-health score, customer-intelligence system 102 may use clustering module 204 to segment customer data into component parts by analyzing similarities among the feature space. Herein, reference to a feature may encompass a KPI, and vice versa, where appropriate. This may provide users with a deeper understanding of the data-normalization-and-inference process without requiring users to be well versed in machine learning (ML) or statistics. Particular embodiments provide a renewal-probability score for each customer based on a seven-feature or nine-feature model. In particular embodiments, clustering module 204 uses SHapley Additive exPlanations (SHAP) via Shapley values to represent feature weightages. Clustering module 204 may also incorporate segmentation using a K-Means Clustering Algorithm with Elbow Method to determine K. Clustering module 204 may also review which of all possible features are available for a particular business. In particular embodiments, use of clustering module 204 in customer-intelligence system 102 facilitates scaling the clustering and benchmarking process and clustering module 204 provides deep context on the feature space to help users contextualize the renewal probability outputs and understand customer segmentation in a comprehensive user interface (UI).

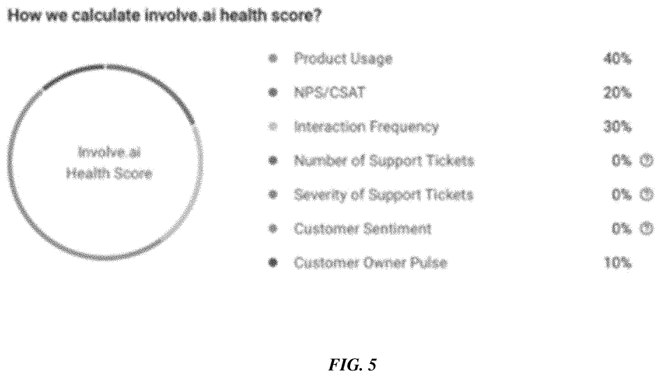

FIG. 5 illustrates example KPI weighting in example customer-health score generation. Particular embodiments combine feature existence, weightage analysis, clustering, and benchmarking in a comprehensive UI for customer-health-score understanding and validation. In the example of FIG. 5, four KPIs are used to generate a customer-health score (product usage, NPS/CSAT, interaction frequency, and customer-owner pulse), with other KPIs being unavailable and weighted at zero. In particular embodiments, dynamic-clustering component parts are available on customer-intelligence dashboard 302. The data will be refreshed on a weekly basis, generating new segments, existence analysis, and feature weightages to be displayed in the Clustering tab of the product.

Particular embodiments facilitate better understanding of the relevance of each KPI and provide information describing the relative weightage of each KPI based on SHAP. The KPIs may be color coded and are represented in a pie chart. The outcome is a visual representation of the relative weightages of each feature component of the health-score algorithm executed by health-score module 206. In particular embodiments, the health-score model takes normalized numeric X={0, 1, 2} features and returns the numeric prediction Y={0, . . . ,99}. To achieve the 0, 1, or 2 normalized values over the KPIs, particular embodiments use the following function:

```
def normalize(data,min,mean):
  if pd.isna(data):
    return data, ‘Does not Exist’
  norm = 2.*(data − min)/(mean −min) − 1
  if norm < −0.4:
    return 0, ‘Low’
  elif norm >0.3:
    return 2, ‘High’
  elif norm >= −0.4 and norm <= 0.3:
    return 1, ‘Medium’
```

In the above function, the min and mean values come from the column that corresponds to the individual metric from the client's raw data. For example, if there is a column corresponding to Interaction Frequency: Emails with values [5, 7, 3, 11], then the normalize() function receives the column, 3, and 11 as inputs and returns the 0, 1, or 2 normalized values for each row. If there is a metric with several components (say Interaction Frequency includes both Emails and Calls) then each component metric is individually normalized according to the above definition. Next, the mean of each row may be computed for the component metrics as follows:
df[‘product_usage)’]=df[[‘product_usage_emails)’,‘product_usage_calls_’]].mean(axis=1)
   Particular embodiments take df[‘product_usage_’] and convert those values back to whole numbers 0, 1, or 2 as taking the average of the rows may have resulted in decimal outputs. To do this particular embodiments, pass the ‘product_usage_’ column to the following function:

```
def normalize_II(data):
  if pd.isna(data):
    return data, ‘Does not Exist’
  if(data > 1):
    return int(2), ‘High’
  elif(data < 1 ):
    return int(0), ‘Low’
  else:
    return int(1), ‘Medium’
```

In particular embodiments, this is how the high, medium, and low values are achieved, which are used as filtering criteria when computing the benchmarks per cluster.

In particular embodiments, the percentages come from SHAP analysis on the back end, which takes the fitted LinearLearner as input and returns the SHAP value per feature. Clustering module 204 further decomposes the SHAP values from an abstract representation based on the difference between the baseline model output and the current model output for the prediction being explained to a float percentage. In particular embodiments, scaling the SHAP values to a percentage (e.g. as shown below) may help the user better understand which KPIs contribute the most to the health scores for their customer accounts, based on their unique customer data.

| features | importance | percent |
|---|---|---|
| product_usage | 9.813389 | 0.436429 |
| interaction_frequency | 5.137598 | 0.228484 |
| severity_score | 4.896132 | 0.217745 |
| NPS/CSAT | 2.333693 | 0.103786 |
| renewal_sentiment | 0.304825 | 0.013556 |
| customer_pulse | 0.000000 | 0.000000 |

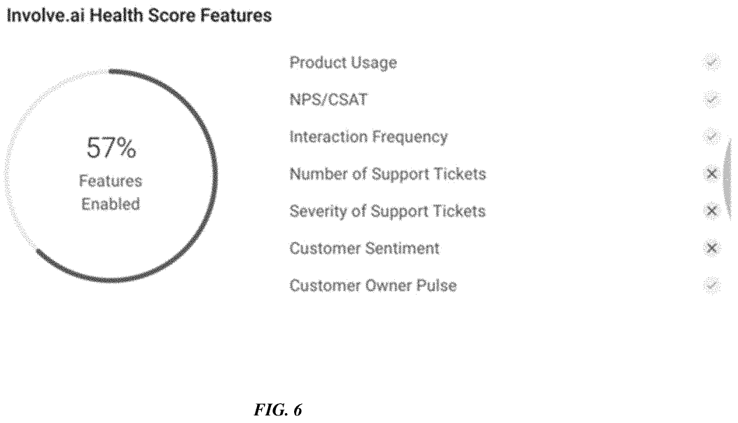

In particular embodiments, features represent the key elements that contribute to the customer's health score. Particular embodiments show the customer, the presence, and the contribution made by each KPI. Customer-intelligence system 102 checks the existence of these KPIs for a business and helps the user understand those KPIs better. In particular embodiments, the values are represented in Boolean (e.g. true if the feature exists and value exists in the client's customer data, else the features will be marked as false). This may help the business to understand what features exist in the database. As an example, the following KPIs may be used, in any suitable combination: (1) product usage, (2) interaction frequency, (3) NPS/CSAT, (4) number of support tickets, (5) severity of support tickets, (6) customer sentiment, (7) customer-owner pulse, (8) up-sells/down-sells, and (9) customer maturity. FIG. 6 illustrates example feature enablement in an example customer-health score, which may be presented to a user to help the user better understand the customer-health score being provided.

In particular embodiments, K-means is used to generate customer-health scores. K-means is an unsupervised ML algorithm that groups similar data points together and discovers underlying patterns. To achieve this, K-means looks for a fixed number of K clusters in a dataset. Particular embodiments define the K-number of clusters for the customers data based on a result derived from the Elbow method. K-means identifies K number of centroids and then allocates every data point to the nearest cluster, while keeping the centroids as small as possible. In particular embodiments, K-means clustering involves the following steps:

1. Select the number of clusters for the dataset (K).

2. Select K number of centroids.

3. By calculating the Euclidean distance or Manhattan distance, assign the points to the nearest centroid, thus creating K groups.

4. Find the original centroid in each group.

5. Again reassign the whole data point based on this new centroid, then repeat step four above until the position of the centroid does not change.

Finding the optimal number of clusters is an important part of this algorithm. Particular embodiments use the Elbow method to find an optimal K value. The number of clusters is determined using the Elbow method, which involves running the algorithm multiple times over a loop on the client's customer data, with an increasing number of cluster choice and then plotting a clustering score as a function of the number of clusters.

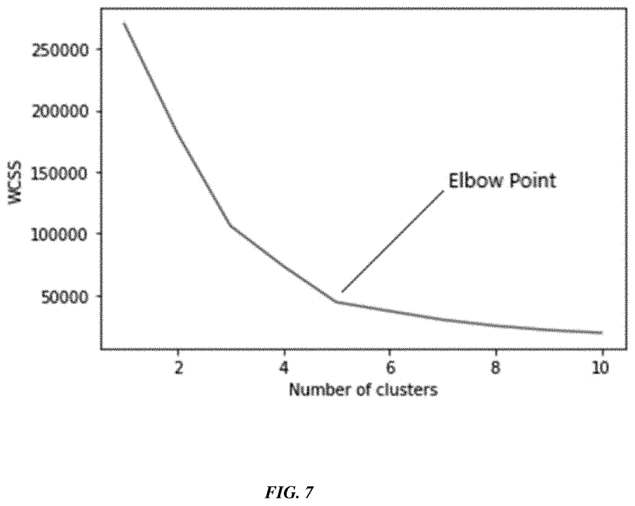

In particular embodiments, the Elbow method varies the number of clusters (K) from one to 10. For each value of K, Within-Cluster Sum of Square (WCSS) is calculated. WCSS is the sum of squared distance between each point and the centroid in a cluster. When the WCSS is plotted with the K value, the plot looks like an Elbow. FIG. 7 illustrates an example Elbow-method graph. As the example of FIG. 7. illustrates, the WCSS value starts to decrease as the number of clusters increases. WCSS value is largest when K=1. The graph will rapidly change at a particular point and thus create an elbow shape. From this point, the graph starts to move almost parallel to the X-axis. The K value corresponding to this point is the optimal K value or an optimal number of clusters. With the optimal K value from the Elbow method, particular embodiments then run the K means over the client's customer data to divide them into K groups. They are then saved separately to analyze each cluster based on the KPI values present.

In particular embodiments, after running the K-means clustering algorithm on the client's customer data and assigning the cluster values to each row, the customer data may then be separate and saved separately for further analysis. Particular embodiments iterate through each cluster and describe the key features for the client in each cluster, like customer count in each cluster, average revenue for each cluster, active versus churned users in each cluster, etc. The benchmarks for the KPIs are also calculated by evaluating the minimum and the maximum value for each category present. For example, a KPI will have “Low,” “Medium,” and “High” categories and the user will be able to see the minimum and maximum value in each category, which will help the user get an idea of how each KPI is contributing to the overall performance (or customer-health score). If a business has significantly lower values for any KPI on any cluster, then the business can focus on the customers that are present inside that cluster to find the similarities among that business's customers and strategize better.

In particular embodiments, after clustering module 204 has processed each component part of the customer data, the customer data is unified for deployment. In particular embodiments, the result is a JSON file containing the following:
Timestamp: The deployment time (e.g. UTC)
Health Score
   Name of metric (i.e.: product usage, interaction frequency, etc.)
   Value: SHAP value converted to a float percentage
   Available: Boolean value representing existence
Segments
Name: Name of the segment (e.g.: cluster 1, cluster 2, . . . )
   Description
      Number of customers per cluster
      Average revenue per customer per cluster
      Number of customers per cluster with an active subscription to the product or service
      Average amount of money active customers spend on the product or service
      Number of customers per cluster that terminated their subscription to the product or service
      Average amount of money churned customers spent on the product or service when they were active
      Active customers by name
      Churned customers by name
   Benchmarks
      Name of metric (i.e.: product usage, interaction frequency, etc.)
      Items
         Name of metric per KPI (i.e.: Interaction Frequency: E-mails, Interaction Frequency: Calls)
         High
         From: Minimum of the metric's raw values (e.g.: For this cluster, the smallest number of e-mails that may be exchanged for a company to still be considered to have overall high interaction frequency)
         To: Maximum of the metric's raw values (e.g.: For this cluster, this will be the highest number of e-mails exchanged across the dataset)
         Medium
         From: Minimum of the metric's raw values (e.g.: For this cluster, the smallest number of e-mails that may be exchanged for a company to still be considered to have overall medium interaction frequency)
         To: Maximum of the metric's raw values (e.g.: For this cluster, the largest number of e-mails that may be exchanged for a company to still be considered to have overall medium interaction frequency)
         Low
         From: Minimum of the metric's raw values (e.g.: For this cluster, this will be the lowest number of e-mails exchanged across the dataset)
         To: Maximum of the metric's raw values (e.g.: For this cluster, the largest number of e-mails that may be exchanged for a company to still be considered to have overall low interaction frequency)

In the above JSON file, there are x segments, depending on the number of clusters identified by the Elbow Method. Each segment is a nested dictionary with “name,” “description,” and “benchmarks” components. Within “Benchmarks,” wherever a given KPI does not contain component metrics, there will only be one associated column of raw data, so the “items” object is unnecessary. In that case, “Benchmarks” will contain “Column_id,” “High,” “Medium,” and “Low.” Also, within “Benchmarks,” “High” corresponds to the normalized numerical feature 2, “Medium” corresponds to the normalized numerical feature 1, and “Low” corresponds to the normalized numerical feature 0.

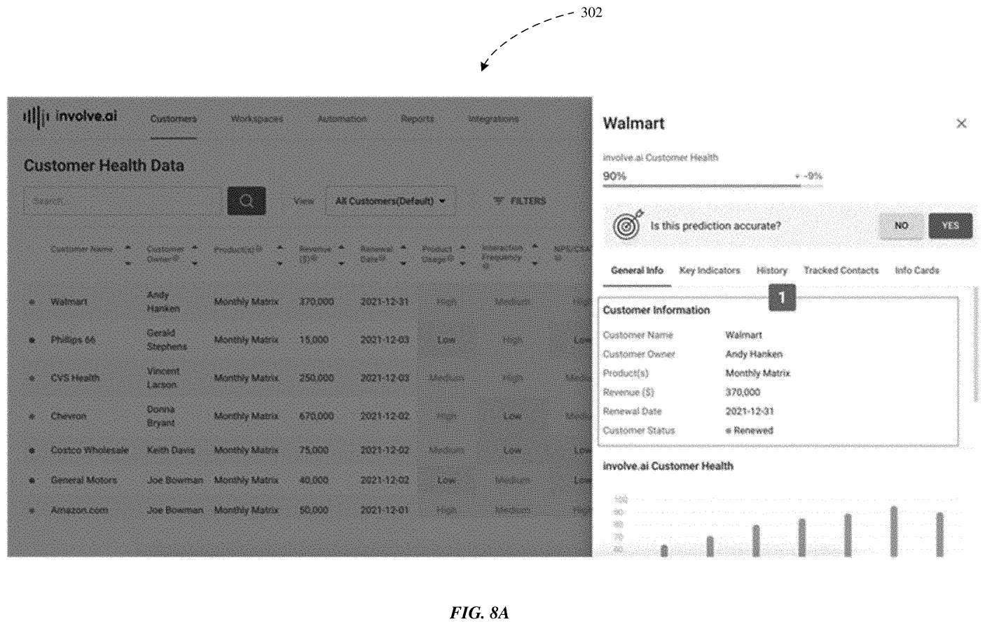

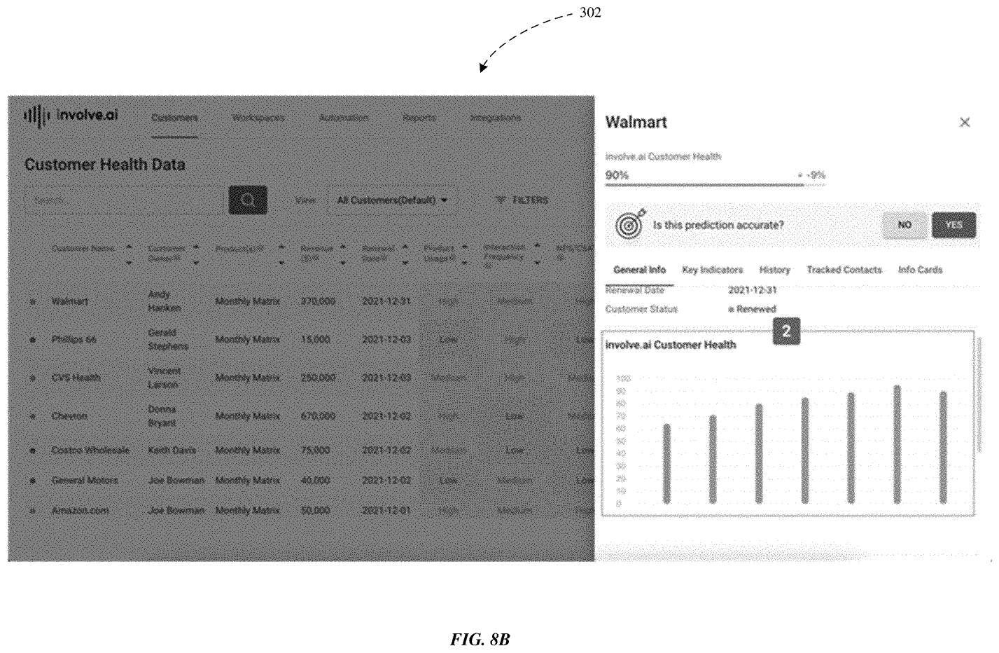

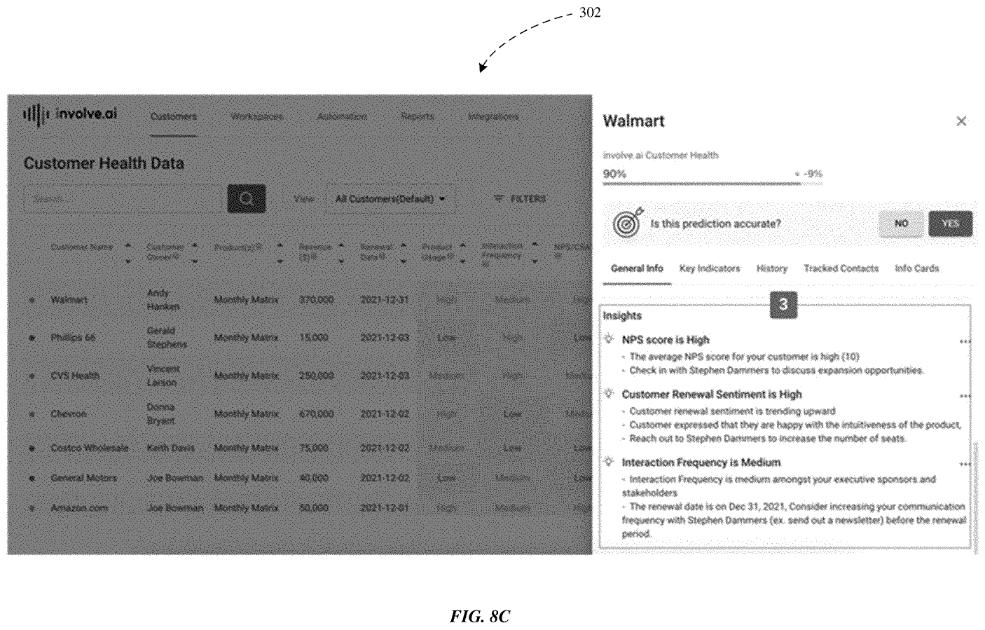

Returning to customer-intelligence dashboard 302, FIGS. 8A-8C illustrate example presentation of example general information on an example customer in an example customer-intelligence dashboard 302. In particular embodiments, general information for a customer may include high-level customer information, customer-health trend, and customer insights. The high-level customer information may include the following: customer name, customer-owner (or CSM) name, product(s), revenue (e.g. ARR), renewal date for the customer, and customer status (e.g. renewed or churned). The customer-health trend may show how customer health for that customer (high, medium, or low) has been trending since the launch of the product. The customer insights may include recommendations that help the user to dive deeper into the account with actionable insights on how to proceed. The customer insights may provide insights about customers that require immediate attention while managing a business's top 10 accounts, along with account details, churn/expansion profiles, and recommendations on next steps. These insights may be the results of analysis using trained AI models that analyze KPIs and best practices for customer success to give the user more accurate and intuitive recommendations to prevent churn and accelerate upsells.

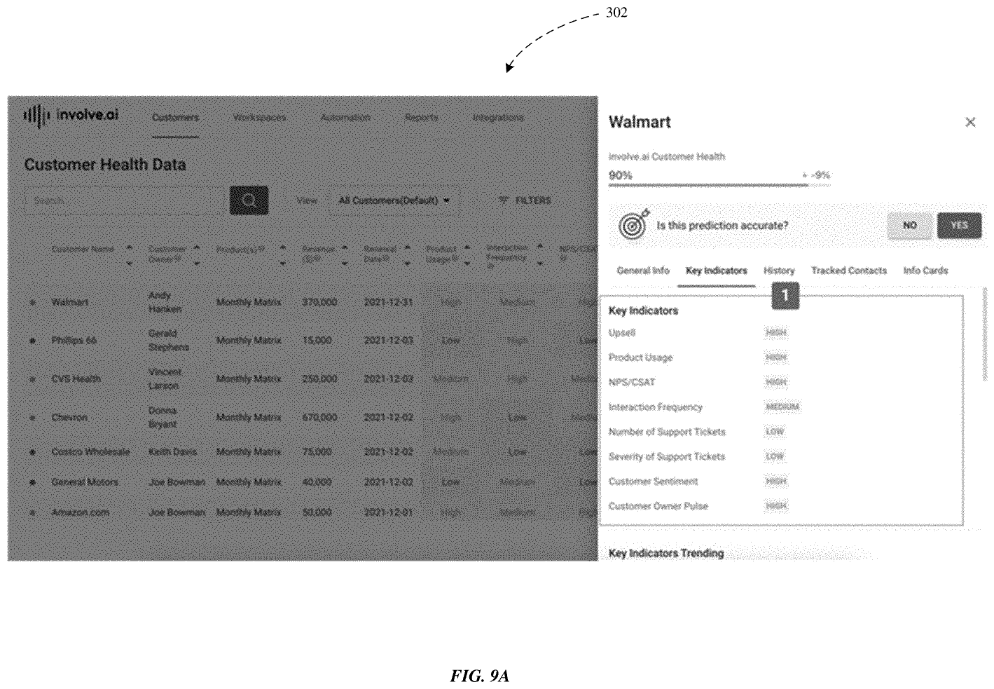

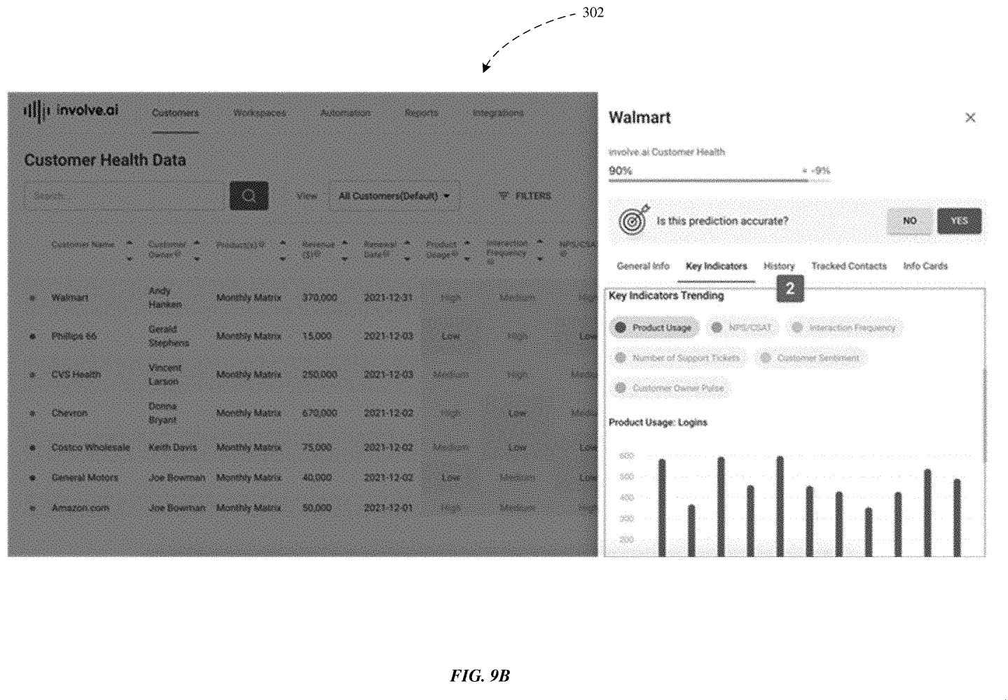

FIGS. 9A-9B illustrates example presentation of example key indicators for an example customer on an example customer-intelligence dashboard 302. In particular embodiments, key indicators provide an extension of high-level customer information, including KPIs measured as high, medium, or low and associated trends with each KPI.

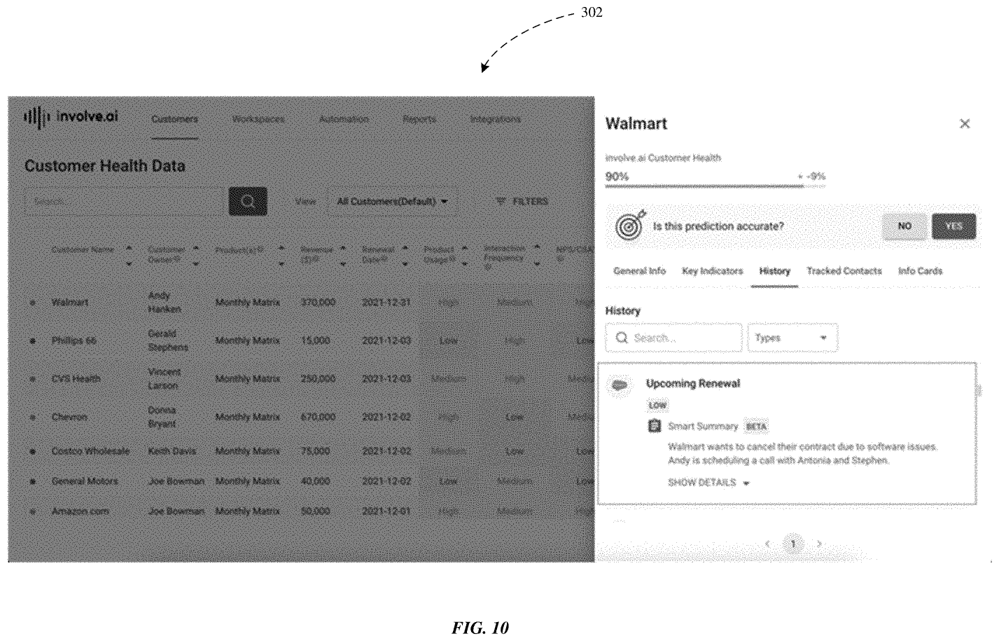

FIG. 10 illustrates example presentation of example customer history for an example customer on an example customer-intelligence dashboard 302. In particular embodiments, a history window provides access to all interaction information associated with the customer. This may include chronological information of updates to the KPIs week over week or month over month, depending on how often the dashboard is refreshed. It may also include e-mail content and e-mail sentiment (e.g. whether the e-mail is positive (high), negative (low), or neutral (medium)). This scoring may be based on sentiment analysis of each e-mail and particular pre-determined keywords. This may help the user access historical data and, using AI, assess that data to determine next steps.

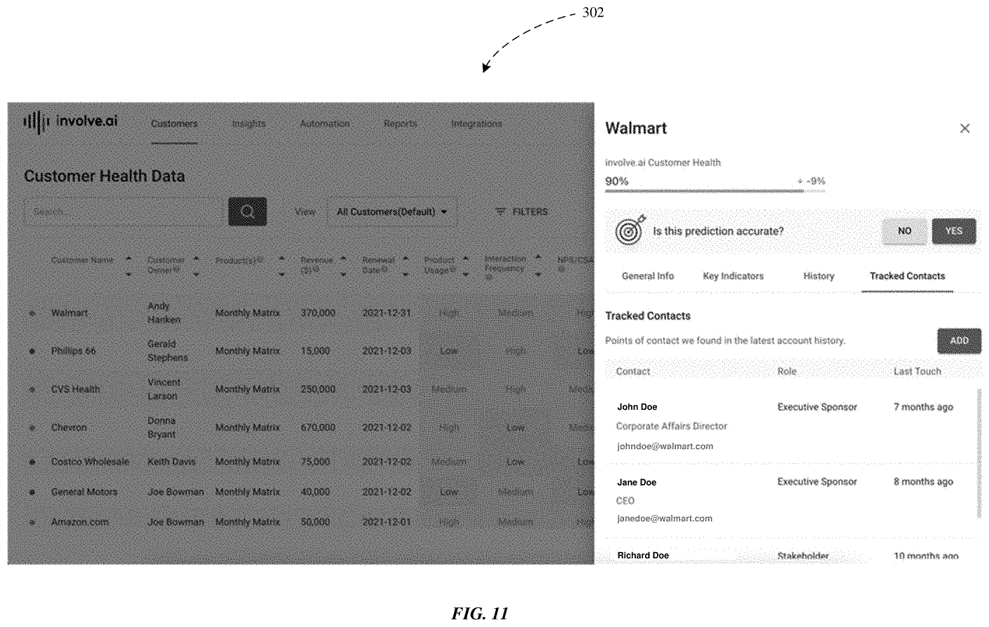

FIG. 11 illustrates example presentation of example tracked contacts for an example customer on an example customer-intelligence dashboard 302. In particular embodiments, a tracked-contacts window enables the user to track all stakeholders associated with the customer. It may also enable the user to add more stakeholder information. This information may be retrieved through AI running on customer interactions.

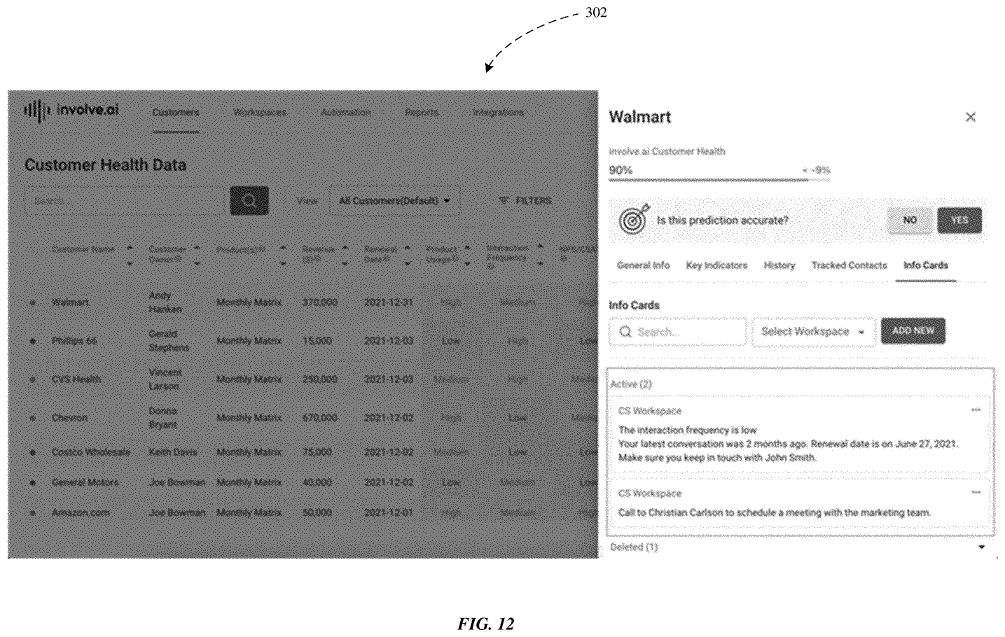

FIG. 12 illustrates example presentation of example information cards on an example customer on an example customer-intelligence dashboard 302. In particular embodiments, the user may create information cards with action items and delegations to colleagues or the user based on the predictions and recommendations provided by customer-intelligence system. This may serve as a single location where the user and the user's colleagues may see unified customer data for one or more customers, along with predictions, recommendations, and action items.

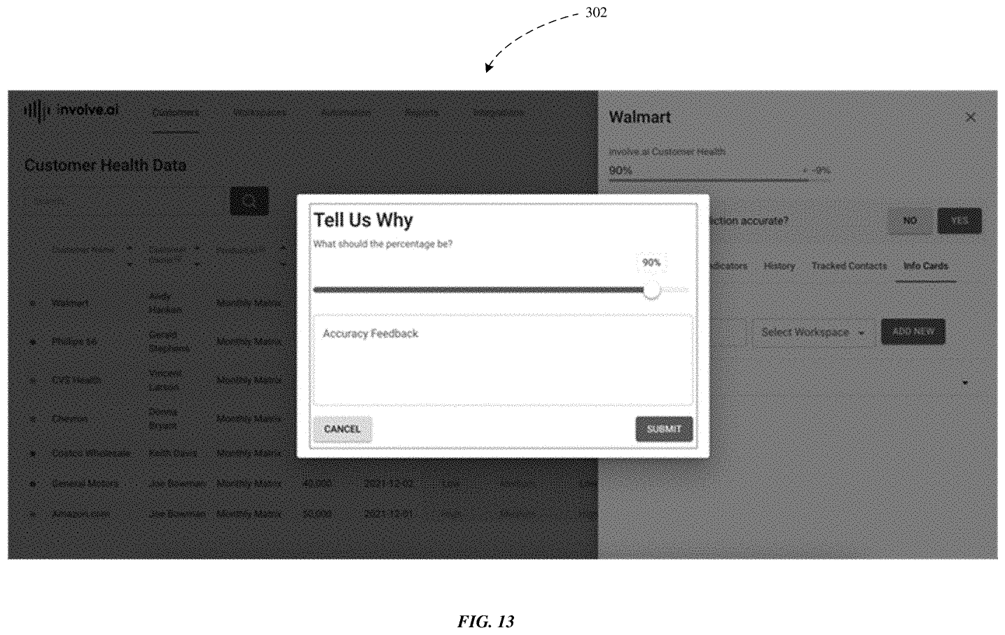

FIG. 13 illustrates an example window for example prediction feedback on an example customer-intelligence dashboard 302. In particular embodiments, customer-intelligence dashboard 302 enables the user to provide feedback and establish a continuous feedback loop if the user wants to add additional context or other information to predictions or recommendations being generated by customer-intelligence system 102, which may enable continual training of the AI of customer-intelligence system 102 based on varying business models.

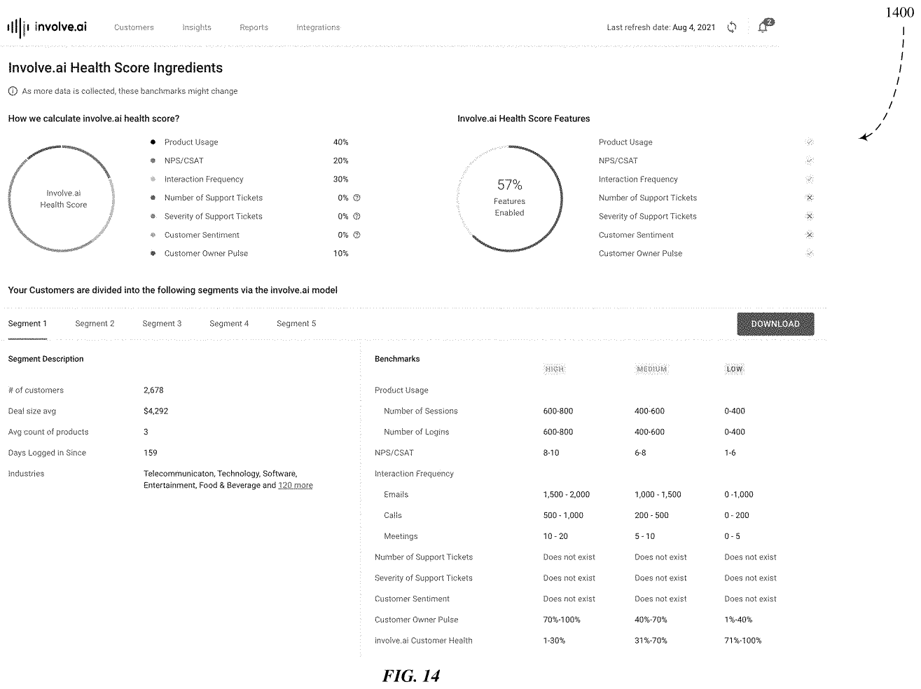

FIG. 14 illustrates example window 1400 presenting KPIs and their contributions to a customer-health score. In the example of FIG. 14, a user may select an icon (not illustrated in FIG. 14) on customer-intelligence dashboard 302 and, in response, be directed to window 1400. In window 1400, a user may select a segment and view a description and breakdown of the segment. In addition, the user may view the benchmarking used with each KPI to determine the scores (high, medium, and low) that are being presented for the KPIs and a breakdown of the data for each KPI.

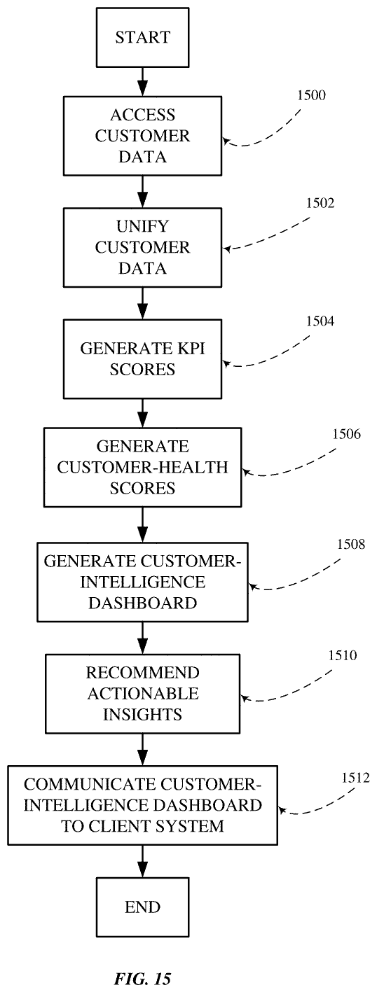

FIG. 15 illustrates an example method for providing a customer-intelligence dashboard. The method may begin at step 1500, where customer-intelligence system 102 accesses customer data of a business entity at data sources 104. As described above, the customer data may include product-usage signals, support signals, and communication signals associated with each of multiple customers and each of one or more products of the business entity. In addition, the customer data may include quantitative data and qualitative data. The method then proceeds to step 1502, where customer-intelligence system 102 unifies the customer data by applying one or more AI models to the customer data. The method then proceeds to step 1504, where, based on the analysis of the customer data, customer-intelligence system 102 generates, for each of the customers and each of the products, a score for each of multiple KPIs for the business entity. As described above, the KPIs may include one or more of the following: product usage; interaction frequency; NPS/CSAT; number of support tickets; severity of support tickets; customer sentiment; customer-owner pulse; up-sells or down-sells; or customer maturity. The method then proceeds to step 1506, where customer-intelligence system 102 generates based on the KPIs a customer-health score for each of the customers and each of the products. As described above, the KPIs may be weighted in the customer-health scores according to SHAP. The method then proceeds to step 1508, where customer-intelligence system 102 generates customer-intelligence dashboard 302 presenting the KPIs and customer-health scores for each of the customers and each of the products. The method then proceeds to step 1510, where customer-intelligence system 102 recommends one or more actionable insights for each of the customers and each of the products based on one or more of the KPI scores or the customer-health scores. The method then proceeds to step 1512, where, in response to a request from a client system 106, customer-intelligence system 102 communicates customer-intelligence dashboard 302 to client system 106 for presentation to a user, at which point the method may end.

Particular embodiments may repeat one or more steps of the method of FIG. 15, where appropriate. Although this disclosure describes and illustrates particular steps of the method of FIG. 15 as occurring in a particular order, this disclosure contemplates any suitable steps of the method of FIG. 15 occurring in any suitable order. Moreover, although this disclosure describes and illustrates an example method for providing a customer-intelligence dashboard including the particular steps of the method of FIG. 15, this disclosure contemplates any suitable method for providing a customer-intelligence dashboard including any suitable steps, which may include all, some, or none of the steps of the method of FIG. 15, where appropriate. Furthermore, although this disclosure describes and illustrates particular components, devices, or systems carrying out particular steps of the method of FIG. 15, this disclosure contemplates any suitable combination of any suitable components, devices, or systems carrying out any suitable steps of the method of FIG. 15.

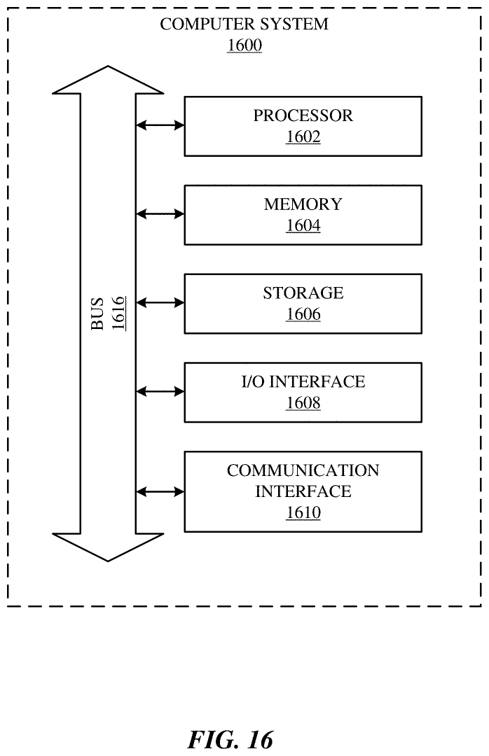

FIG. 16 illustrates an example computer system 1600. In particular embodiments, one or more computer systems 1600 perform one or more steps of one or more methods described or illustrated herein. In particular embodiments, one or more computer systems 1600 provide functionality described or illustrated herein. In particular embodiments, software running on one or more computer systems 1600 performs one or more steps of one or more methods described or illustrated herein or provides functionality described or illustrated herein. Particular embodiments include one or more portions of one or more computer systems 1600. Herein, reference to a computer system may encompass a computing device, and vice versa, where appropriate. Moreover, reference to a computer system may encompass one or more computer systems, where appropriate.

This disclosure contemplates any suitable number of computer systems 1600. This disclosure contemplates computer system 1600 taking any suitable physical form. As example and not by way of limitation, computer system 1600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1600 may include one or more computer systems 1600; be unitary or distributed; span multiple locations; span multiple machines; span multiple data centers; or reside in a cloud, which may include one or more cloud components in one or more networks. Where appropriate, one or more computer systems 1600 may perform without substantial spatial or temporal limitation one or more steps of one or more methods described or illustrated herein. As an example and not by way of limitation, one or more computer systems 1600 may perform in real time or in batch mode one or more steps of one or more methods described or illustrated herein. One or more computer systems 1600 may perform at different times or at different locations one or more steps of one or more methods described or illustrated herein, where appropriate.

In particular embodiments, computer system 1600 includes a processor 1602, memory 1604, storage 1606, an input/output (I/O) interface 1608, a communication interface 1610, and a bus 1616. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1602 includes hardware for executing instructions, such as those making up a computer program. As an example and not by way of limitation, to execute instructions, processor 1602 may retrieve (or fetch) the instructions from an internal register, an internal cache, memory 1604, or storage 1606; decode and execute them; and then write one or more results to an internal register, an internal cache, memory 1604, or storage 1606. In particular embodiments, processor 1602 may include one or more internal caches for data, instructions, or addresses. This disclosure contemplates processor 1602 including any suitable number of any suitable internal caches, where appropriate. As an example and not by way of limitation, processor 1602 may include one or more instruction caches, one or more data caches, and one or more translation lookaside buffers (TLBs). Instructions in the instruction caches may be copies of instructions in memory 1604 or storage 1606, and the instruction caches may speed up retrieval of those instructions by processor 1602. Data in the data caches may be copies of data in memory 1604 or storage 1606 for instructions executing at processor 1602 to operate on; the results of previous instructions executed at processor 1602 for access by subsequent instructions executing at processor 1602 or for writing to memory 1604 or storage 1606; or other suitable data. The data caches may speed up read or write operations by processor 1602. The TLBs may speed up virtual-address translation for processor 1602. In particular embodiments, processor 1602 may include one or more internal registers for data, instructions, or addresses. This disclosure contemplates processor 1602 including any suitable number of any suitable internal registers, where appropriate. Where appropriate, processor 1602 may include one or more ALUs; be a multi-core processor; or include one or more processors 1602. Although this disclosure describes and illustrates a particular processor, this disclosure contemplates any suitable processor.

In particular embodiments, memory 1604 includes main memory for storing instructions for processor 1602 to execute or data for processor 1602 to operate on. As an example and not by way of limitation, computer system 1600 may load instructions from storage 1606 or another source (such as, for example, another computer system 1600) to memory 1604. Processor 1602 may then load the instructions from memory 1604 to an internal register or internal cache. To execute the instructions, processor 1602 may retrieve the instructions from the internal register or internal cache and decode them. During or after execution of the instructions, processor 1602 may write one or more results (which may be intermediate or final results) to the internal register or internal cache. Processor 1602 may then write one or more of those results to memory 1604. In particular embodiments, processor 1602 executes only instructions in one or more internal registers or internal caches or in memory 1604 (as opposed to storage 1606 or elsewhere) and operates only on data in one or more internal registers or internal caches or in memory 1604 (as opposed to storage 1606 or elsewhere). One or more memory buses (which may each include an address bus and a data bus) may couple processor 1602 to memory 1604. Bus 1616 may include one or more memory buses, as described below. In particular embodiments, one or more memory management units (MMUs) reside between processor 1602 and memory 1604 and facilitate accesses to memory 1604 requested by processor 1602. In particular embodiments, memory 1604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1604 may include one or more memories 1604, where appropriate. Although this disclosure describes and illustrates particular memory, this disclosure contemplates any suitable memory.

In particular embodiments, storage 1606 includes mass storage for data or instructions. As an example and not by way of limitation, storage 1606 may include a hard disk drive (HDD), a floppy disk drive, flash memory, an optical disc, a magneto-optical disc, magnetic tape, or a Universal Serial Bus (USB) drive or a combination of two or more of these. Storage 1606 may include removable or non-removable (or fixed) media, where appropriate. Storage 1606 may be internal or external to computer system 1600, where appropriate. In particular embodiments, storage 1606 is non-volatile, solid-state memory. In particular embodiments, storage 1606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1606 taking any suitable physical form. Storage 1606 may include one or more storage control units facilitating communication between processor 1602 and storage 1606, where appropriate. Where appropriate, storage 1606 may include one or more storages 1606. Although this disclosure describes and illustrates particular storage, this disclosure contemplates any suitable storage.

In particular embodiments, I/O interface 1608 includes hardware, software, or both, providing one or more interfaces for communication between computer system 1600 and one or more I/O devices. Computer system 1600 may include one or more of these I/O devices, where appropriate. One or more of these I/O devices may enable communication between a person and computer system 1600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1608 for them. Where appropriate, I/O interface 1608 may include one or more device or software drivers enabling processor 1602 to drive one or more of these I/O devices. I/O interface 1608 may include one or more I/O interfaces 1608, where appropriate. Although this disclosure describes and illustrates a particular I/O interface, this disclosure contemplates any suitable I/O interface.

In particular embodiments, communication interface 1610 includes hardware, software, or both providing one or more interfaces for communication (such as, for example, packet-based communication) between computer system 1600 and one or more other computer systems 1600 or one or more networks. As an example and not by way of limitation, communication interface 1610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1610 for it. As an example and not by way of limitation, computer system 1600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1600 may include any suitable communication interface 1610 for any of these networks, where appropriate. Communication interface 1610 may include one or more communication interfaces 1610, where appropriate. Although this disclosure describes and illustrates a particular communication interface, this disclosure contemplates any suitable communication interface.

In particular embodiments, bus 1616 includes hardware, software, or both coupling components of computer system 1600 to each other. As an example and not by way of limitation, bus 1616 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards

Association local (VLB) bus, or another suitable bus or a combination of two or more of these. Bus 1616 may include one or more buses 1616, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. The embodiments disclosed herein are only examples, and the scope of this disclosure is not limited to them. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Particular embodiments may include all, some, or none of the components, elements, features, functions, operations, or steps of the embodiments disclosed herein. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
by one or more computing devices of a customer-intelligence system, accessing a plurality of customer data of a business entity at a plurality of data sources, wherein:
the customer data comprises product-usage signals, support signals, and communication signals associated with each of a plurality of customers and each of one or more products of the business entity;
at least some of the customer data is quantitative; and
at least some of the customer data is qualitative;
by the computing devices, analyzing the customer data by applying one or more artificial intelligence (AI) models to the customer data;
by the computing devices, based on the analysis of the customer data, determining, for each of the customers and each of the products a score for each of a plurality of key performance indicators (KPIs) for the business entity, wherein the KPIs comprise one or more of the following:
product usage;
interaction frequency;
net promoter score (NPS) or customer satisfaction (CSAT) score;
number of support tickets;
severity of support tickets;
customer sentiment;
customer-owner pulse;
up-sells or down-sells; or
customer maturity;
by the computing devices, generating a user-navigable dashboard presenting the KPIs for each of the customers and each of the products; and
by the computing devices, in response to a request from a client device, communicating the user-navigable dashboard to the client device for display to a user.

2. The method of claim 1, further comprising:
by the computing devices, based on the KPI scores, determining, for each of the customers and each of the products, a customer-health score for the business entity;
by the computing devices, presenting the customer-health scores in the user-navigable dashboard.

3. The method of claim 1, wherein the customer data comprises one or more of the following:
support tickets;
e-mails;
telephone calls;
chats;
text messages;
NPS or CSAT comments;
logins;
sessions;
session times;
API calls;
API throttle limits;
API usage cyclicity;
report downloads;
page views;
commercial transactions;
billable actions;
non-billable actions;
value-added actions;
product add-ons;
time on product;
quote-to-order conversion;
invoices generated; or order volume.

4. The method of claim 1, wherein:
product usage comprises a frequency at which a customer uses or purchases a product;
interaction frequency comprises a frequency of interaction between a customer and the business entity;
NPS and CSAT comprises a level of customer satisfaction;
number of support tickets comprises a number of support requests submitted by a customer for a product over a predetermined period of time;
severity of support tickets comprises a severity of issues in the support tickets;
customer sentiment comprises an analysis of written interaction between the business entity and a customer regarding a product;
customer-owner pulse comprises an assessment of a relationship between the business entity and a customer regarding a product;
up-sells or down-sells comprises an increase or decrease in revenue generated from the customer over the predetermined period of time; and
customer maturity comprises where a customer is in a customer lifecycle with respect to the business entity and a product.

5. The method of claim 1, wherein the user-navigable dashboard comprises a grid with customers and corresponding products being displayed in rows and the corresponding KPI scores being displayed in columns intersecting the rows.

6. The method of claim 1, wherein, as presented in the user-navigable dashboard, the KPI scores are color coded according to whether they are positive, neutral, or negative.

7. The method of claim 1, wherein the user-navigable dashboard further comprises:
a user selectable general-information window for each customer and corresponding product;
a user selectable key-indicators window for each customer and corresponding product;
a user selectable customer-history window for each customer and corresponding product;
a user selectable tracked-contacts window for each customer and corresponding product;
a user selectable information-card window for each customer and corresponding product; and
a user selectable prediction-feedback window for each customer and corresponding product.

8. A system comprising:
one or more processors; and
one or more computer-readable non-transitory storage media coupled to one or more of the processors and comprising instructions operable when executed by one or more of the processors to cause the system to:
access a plurality of customer data of a business entity at a plurality of data sources, wherein:
the customer data comprises product-usage signals, support signals, and communication signals associated with each of a plurality of customers and each of one or more products of the business entity;
at least some of the customer data is quantitative; and
at least some of the customer data is qualitative;
analyze the customer data by applying one or more artificial intelligence (AI) models to the customer data;
based on the analysis of the customer data, determine, for each of the customers and each of the products a score for each of a plurality of key performance indicators (KPIs) for the business entity, wherein the KPIs comprise one or more of the following:
product usage;
interaction frequency;
net promoter score (NPS) or customer satisfaction (CSAT) score;
number of support tickets;
severity of support tickets;
customer sentiment;
customer-owner pulse;
up-sells or down-sells; or
customer maturity;
generate a user-navigable dashboard presenting the KPIs for each of the customers and each of the products; and
in response to a request from a client device, communicate the user-navigable dashboard to the client device for display to a user.

9. The system of claim 8, wherein the instructions are further operable when executed by one or more of the processors to cause the system to:
based on the KPI scores, determine, for each of the customers and each of the products, a customer-health score for the business entity;
present the customer-health scores in the user-navigable dashboard.

10. The system of claim 8, wherein the customer data comprises one or more of the following:
support tickets;
e-mails;
telephone calls;
chats;
text messages;
NPS or CSAT comments;
logins;
sessions;
session times;
API calls;
API throttle limits;
API usage cyclicity;
report downloads;
page views;
commercial transactions;
billable actions;
non-billable actions;
value-added actions;
product add-ons;
time on product;
quote-to-order conversion;
invoices generated; or
order volume.

11. The system of claim 8, wherein:
product usage comprises a frequency at which a customer uses or purchases a product;
interaction frequency comprises a frequency of interaction between a customer and the business entity;
NPS and CSAT comprises a level of customer satisfaction;
number of support tickets comprises a number of support requests submitted by a customer for a product over a predetermined period of time;
severity of support tickets comprises a severity of issues in the support tickets;
customer sentiment comprises an analysis of written interaction between the business entity and a customer regarding a product;
customer-owner pulse comprises an assessment of a relationship between the business entity and a customer regarding a product;
up-sells or down-sells comprises an increase or decrease in revenue generated from the customer over the predetermined period of time; and
customer maturity comprises where a customer is in a customer lifecycle with respect to the business entity and a product.

12. The system of claim 8, wherein the user-navigable dashboard comprises a grid with customers and corresponding products being displayed in rows and the corresponding KPI scores being displayed in columns intersecting the rows.

13. The system of claim 8, wherein, as presented in the user-navigable dashboard, the KPI scores are color coded according to whether they are positive, neutral, or negative.

14. The system of claim 8, wherein the user-navigable dashboard further comprises:
a user selectable general-information window for each customer and corresponding product;
a user selectable key-indicators window for each customer and corresponding product;
a user selectable customer-history window for each customer and corresponding product;
a user selectable tracked-contacts window for each customer and corresponding product;
a user selectable information-card window for each customer and corresponding product; and
a user selectable prediction-feedback window for each customer and corresponding product.

15. One or more computer-readable non-transitory storage media embodying software that is operable when executed to:
access a plurality of customer data of a business entity at a plurality of data sources, wherein:
the customer data comprises product-usage signals, support signals, and communication signals associated with each of a plurality of customers and each of one or more products of the business entity;
at least some of the customer data is quantitative; and
at least some of the customer data is qualitative;
analyze the customer data by applying one or more artificial intelligence (AI) models to the customer data;
based on the analysis of the customer data, determine, for each of the customers and each of the products a score for each of a plurality of key performance indicators (KPIs) for the business entity, wherein the KPIs comprise one or more of the following:
product usage;
interaction frequency;
net promoter score (NPS) or customer satisfaction (CSAT) score;
number of support tickets;
severity of support tickets;
customer sentiment;
customer-owner pulse;
up-sells or down-sells; or
customer maturity;
generate a user-navigable dashboard presenting the KPIs for each of the customers and each of the products; and
in response to a request from a client device, communicate the user-navigable dashboard to the client device for display to a user.

16. The media of claim 15, wherein the software is further operable when executed to:
based on the KPI scores, determine, for each of the customers and each of the products, a customer-health score for the business entity;
present the customer-health scores in the user-navigable dashboard.

17. The media of claim 15, wherein the customer data comprises one or more of the following:
support tickets;
e-mails;
telephone calls;
chats;
text messages;
NPS or CSAT comments;
logins;
sessions;
session times;
API calls;
API throttle limits;
API usage cyclicity;
report downloads;
page views;
commercial transactions;
billable actions;
non-billable actions;
value-added actions;
product add-ons;
time on product;
quote-to-order conversion;
invoices generated; or
order volume.

18. The media of claim 15, wherein:
product usage comprises a frequency at which a customer uses or purchases a product;
interaction frequency comprises a frequency of interaction between a customer and the business entity;
NPS and CSAT comprises a level of customer satisfaction;
number of support tickets comprises a number of support requests submitted by a customer for a product over a predetermined period of time;
severity of support tickets comprises a severity of issues in the support tickets;
customer sentiment comprises an analysis of written interaction between the business entity and a customer regarding a product;
customer-owner pulse comprises an assessment of a relationship between the business entity and a customer regarding a product;
up-sells or down-sells comprises an increase or decrease in revenue generated from the customer over the predetermined period of time; and
customer maturity comprises where a customer is in a customer lifecycle with respect to the business entity and a product.

19. The media of claim 15, wherein the user-navigable dashboard comprises a grid with customers and corresponding products being displayed in rows and the corresponding KPI scores being displayed in columns intersecting the rows.

20. The media of claim 15, wherein, as presented in the user-navigable dashboard, the KPI scores are color coded according to whether they are positive, neutral, or negative.

21. The media of claim 15, wherein the user-navigable dashboard further comprises:
a user selectable general-information window for each customer and corresponding product;
a user selectable key-indicators window for each customer and corresponding product;
a user selectable customer-history window for each customer and corresponding product;
a user selectable tracked-contacts window for each customer and corresponding product;
a user selectable information-card window for each customer and corresponding product; and
a user selectable prediction-feedback window for each customer and corresponding product.
